(19) United States
(12) Patent Application Publication
(10) Pub. No.: US 2009/0313244 A1
(43) Pub. Date: Dec. 17, 2009

(54) SYSTEM AND METHOD FOR DISPLAYING CONTEXT-RELATED SOCIAL CONTENT ON WEB PAGES

(76) Inventors: Serhii Sokolenko, Seattle, WA (US); Oleksiy Shevchuk, Toronto (CA); Sergii Shevchuk, Kyiv (UA); Roman Khnykin, Kharkiv (UA)

Correspondence Address: Jeremiah J. Baunach;The Law Offices of Jeremiah J. Baunach LLC, Suite 2100, 1700 Seventh Ave., Seattle, WA, 98101, US

(21) Appl. No.: 12/471,401

(22) Filed: May 24, 2009

Related U.S. Application Data
(60) Provisional application No. 61/061,963, filed on Jun. 16, 2008.

(51) Int. Cl. G06F 3/01; G06F 3/048; G06F 17/30

(52) U.S. Cl. 707/5; 715/805; 715/733; 715/808; 707/E17.017

(57) ABSTRACT

A method for displaying context-related social content on web pages may comprise a method wherein one or more computer processors cause performance of steps comprising matching at least one cue with content of at least one web page served by a web site a user has currently open in a web browser of the user, said cue containing social content or objects from other web sites than the web site serving the web page the user currently has open in the web browser.

### CROSS REFERENCE TO RELATED APPLICATIONS

Priority is hereby claimed under 35 U.S.C. 119(e) to provisional U.S. Patent Application 61/061,963 entitled “System and Method for Displaying Context-Related Social Content on Web Pages” filed Jun. 16, 2008, the entirety of which is hereby incorporated by reference.

### BACKGROUND

Social Networking and Social Content Sharing has been increasingly adopted by more and more Internet users. Sharing bookmarks, photographs, opinions, and news with friends and the general public is becoming more mainstream. Companies such as Delicious® and StumbleUpon® pioneered the sharing of bookmarks. Flickr® is an example of a photo sharing site. Millions of bloggers use technology by Blogger®, Wordpress®, Typepad®, LiveJournal®.

With the general adoption of these technologies comes a glut of content. A typical user has from 100 to 300 friends in contact lists across all his services. If even a small percentage of the user's friends are regular contributors of content such as blog postings, photo albums or bookmarks, the user quickly reaches a point where the user cannot follow the stream of social news. Therefore, after the initial sign-up frenzy users are starting to ration their time spent on social sharing services.

Recently, new technologies have come into existence to address some of these issues. Social content aggregators such as FriendFeed® have been combining multiple feeds of bookmarks, photos, etc., for display on their own web site. Facebook® offers their users a news feed from their friends consisting of status updates, announcements of new photographs or new friendship connections. All these approaches are similar in the way that they require the user to visit a specialized web page which lists all newly shared content pieces chronologically.

Aggregation helps users to establish control over all their sources of content, but it contributes to even larger glut of shared content. If previously users were often unaware of one of their friends posting a new bookmark, they currently are guaranteed to obtain an entire and complete list of all their friends' actions. These shared items are often out-of-context of what the user is currently doing or is interested in and are therefore not relevant.

In this regard, there is a need for displaying context-related social content on web pages that addresses the above shortcomings of the prior art.

### SUMMARY

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

In consideration of the above-identified shortcomings of the art, displaying context-related

social content on web pages is provided. For several embodiments, a method for displaying context-related social content on web pages may comprise a method wherein one or more computer processors cause performance of steps comprising matching at least one cue with content of at least one web page served by a web site a user has currently open in a web browser of the user, said cue containing social content or objects from other web sites than the web site serving the web page the user currently has open in the web browser. The at least one cue may then be automatically displayed on the web page currently open in the web browser of the user.

Other advantages and features of the invention are described below.

### BRIEF DESCRIPTION OF THE DRAWINGS

Displaying context-related social content on web pages is further described with reference to the accompanying drawings in which:

FIG. 1 is a block diagram representing an exemplary computing device suitable for use in conjunction with implementing displaying context-related social content on web pages; and

FIG. 2 illustrates an exemplary networked computing environment in which many computerized processes may be implemented to perform displaying context-related social content on web pages;

FIG. 3 is a block diagram illustrating an example architecture of a system for displaying context-related social content on web pages;

FIG. 4 is a block diagram illustrating an example of hierarchical and tag-based classification of objects;

FIG. 5 is an illustration of an example small “toast” window indicating availability of cues for a web page;

FIG. 6 is an illustration of an example large “toast” window displaying cues for an entire web page;

FIG. 7 is an illustration of an example large “toast” window with cues for keywords or links;

FIG. 8 is a flow chart of an example process for finding and displaying relevant cues on a web page in an example system for displaying context-related social content;

FIG. 9a is a flow chart of an example process for web page summarization in an example system for displaying context-related social content;

FIG. 9b is a flow chart of an example process for determining the information value of word phrases in an example system for displaying context-related social content;

FIG. 9c is a flow chart of an example process for displaying cues relevant to high information value word phrases on an overview page in an example system for displaying context-related social content;

FIG. 10 is a flow chart of an example process for finding similar cues in hierarchy-based classification in an example system for displaying context-related social content;

FIG. 11 is a flow chart of an example process for finding similar cues in tag-based classification in an example system for displaying context-related social content;

FIG. 12 is a flow chart of an example process for allowing merchants to specify sponsored cues in an example system for displaying context-related social content;

FIG. 13 is a flow chart of an example process for distributing cues to member databases in an example system for displaying context-related social content;

FIG. 14 is an illustration of a top portion of an example overview page in an example system for displaying context-related social content; and

FIG. 15 is an illustration of a bottom portion of an example overview page in an example system for displaying context-related social content.

### DETAILED DESCRIPTION

Certain specific details are set forth in the following description and figures to provide a thorough understanding of various embodiments of the invention. Certain well-known details often associated with computing and software technology are not set forth in the following disclosure to avoid unnecessarily obscuring the various embodiments of the invention. Further, those of ordinary skill in the relevant art will understand that they can practice other embodiments of the invention without one or more of the details described below. Finally, while various methods are described with reference to steps and sequences in the following disclosure, the description as such is for providing a clear implementation of embodiments of the invention, and the steps and sequences of steps should not be taken as required to practice this invention.

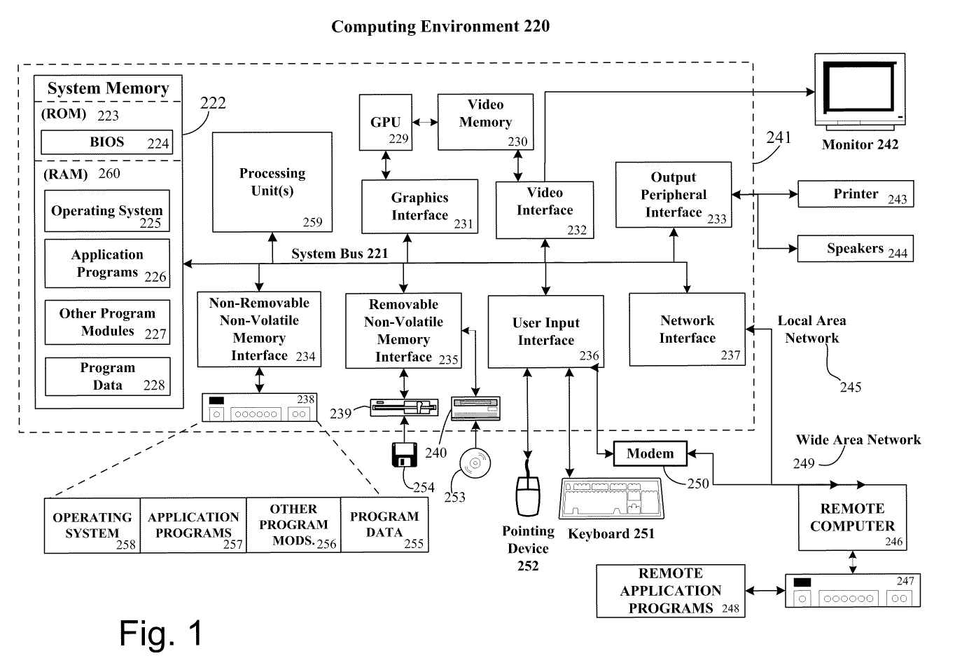

Referring next to FIG. 1, shown is a block diagram representing an exemplary computing device suitable for use in conjunction with implementing the processes described above. For example, the computer executable instructions that carry out the processes and methods for displaying context-related social content on web pages may reside and/or be executed in such a computing environment as shown in FIG. 1. The computing system environment 220 is only one example of a suitable computing environment and is not intended to suggest any limitation as to the scope of use or functionality of the invention. Neither should the computing environment 220 be interpreted as having any dependency or requirement relating to any one or combination of components illustrated in the exemplary operating environment 220. For example a computer game console may also include those items such as those described below for use in conjunction with implementing the processes described above.

Aspects of the invention are operational with numerous other general purpose or special purpose computing system environments or configurations. Examples of well known computing systems, environments, and/or configurations that may be suitable for use with the invention include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

Aspects of the invention may be implemented in the general context of computer-executable instructions, such as program modules, being executed by a computer. Generally, program modules include routines, programs, objects, components, data structures, etc. that perform particular tasks or implement particular abstract data types. Aspects of the invention may also be practiced in distributed computing environments where tasks are performed by remote processing devices that are linked through a communications network. In a distributed computing environment, program modules may be located in both local and remote computer storage media including memory storage devices.

An exemplary system for implementing aspects of the invention includes a general purpose computing device in the form of a computer 241. Components of computer 241 may include, but are not limited to, a processing unit 259, a system memory 222, and a system bus 221 that couples various system components including the system memory to the processing unit 259. The system bus 221 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 241 typically includes a variety of computer readable media. Computer readable media can be any available media that can be accessed by computer 241 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by computer 241. Combinations of the any of the above should also be included within the scope of computer readable media.

The system memory 222 includes computer storage media in the form of volatile and/or nonvolatile memory such as read only memory (ROM) 223 and random access memory (RAM) 260. A basic input/output system 224 (BIOS), containing the basic routines that help to transfer information between elements within computer 241, such as during start-up, is typically stored in ROM 223. RAM 260 typically contains data and/or program modules that are immediately accessible to and/or presently being operated on by processing unit 259. By way of example, and not limitation, FIG. 1 illustrates operating system 225, application programs 226, other program modules 227, and program data 228.

The computer 241 may also include other removable/non-removable, volatile/nonvolatile computer storage media. By way of example only, FIG. 1 illustrates a hard disk drive 238 that reads from or writes to non-removable, nonvolatile magnetic media, a magnetic disk drive 239 that reads from or writes to a removable, nonvolatile magnetic disk 254, and an optical disk drive 240 that reads from or writes to a removable, nonvolatile optical disk 253 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 238 is typically connected to the system bus 221 through an non-removable memory interface such as interface 234, and magnetic disk drive 239 and optical disk drive 240 are typically connected to the system bus 221 by a removable memory interface, such as interface 235.

The drives and their associated computer storage media discussed above and illustrated in FIG. 1, provide storage of computer readable instructions, data structures, program modules and other data for the computer 241. In FIG. 1, for example, hard disk drive 238 is illustrated as storing operating system 258, application programs 257, other program modules 256, and program data 255. Note that these components can either be the same as or different from operating system 225, application programs 226, other program modules 227, and program data 228. Operating system 258, application programs 257, other program modules 256, and program data 255 are given different numbers here to illustrate that, at a minimum, they are different copies. A user may enter commands and information into the computer 241 through input devices such as a keyboard 251 and pointing device 252, commonly referred to as a mouse, trackball or touch pad. Other input devices (not shown) may include a microphone, joystick, game pad, satellite dish, scanner, or the like. These and other input devices are often connected to the processing unit 259 through a user input interface 236 that is coupled to the system bus, but may be connected by other interface and bus structures, such as a parallel port, game port or a universal serial bus (USB). A monitor 242 or other type of display device is also connected to the system bus 221 via an interface, such as a video interface 232. In addition to the monitor, computers may also include other peripheral output devices such as speakers 244 and printer 243, which may be connected through a output peripheral interface 233.

The computer 241 may operate in a networked environment using logical connections to one or more remote computers, such as a remote computer 246. The remote computer 246 may be a personal computer, a server, a router, a network PC, a peer device or other common network node, and typically includes many or all of the elements described above relative to the computer 241, although only a memory storage device 247 has been illustrated in FIG. 1. The logical connections depicted in FIG. 1 include a local area network (LAN) 245 and a wide area network (WAN) 249, but may also include other networks. Such networking environments are commonplace in offices, enterprise-wide computer networks, intranets and the Internet.

When used in a LAN networking environment, the computer 241 is connected to the LAN 245 through a network interface or adapter 237. When used in a WAN networking environment, the computer 241 typically includes a modem 250 or other means for establishing communications over the WAN 249, such as the Internet. The modem 250, which may be internal or external, may be connected to the system bus 221 via the user input interface 236, or other appropriate mechanism. In a networked environment, program modules depicted relative to the computer 241, or portions thereof, may be stored in the remote memory storage device. By way of example, and not limitation, FIG. 1 illustrates remote application programs 248 as residing on memory device 247. It will be appreciated that the network connections shown are exemplary and other means of establishing a communications link between the computers may be used.

It should be understood that the various techniques described herein may be implemented in connection with hardware or software or, where appropriate, with a combination of both. Thus, the methods and apparatus of the invention, or certain aspects or portions thereof, may take the form of program code (i.e., instructions) embodied in tangible media, such as floppy diskettes, CD-ROMs, hard drives, or any other machine-readable storage medium wherein, when the program code is loaded into and executed by a machine, such as a computer, the machine becomes an apparatus for practicing the invention. In the case of program code execution on programmable computers, the computing device generally includes a processor, a storage medium readable by the processor (including volatile and non-volatile memory and/or storage elements), at least one input device, and at least one output device. One or more programs that may implement or utilize the processes described in connection with the invention, e.g., through the use of an API, reusable controls, or the like. Such programs are preferably implemented in a high level procedural or object oriented programming language to communicate with a computer system. However, the program(s) can be implemented in assembly or machine language, if desired. In any case, the language may be a compiled or interpreted language, and combined with hardware implementations.

Although exemplary embodiments may refer to utilizing aspects of the invention in the context of one or more stand-alone computer systems, the invention is not so limited, but rather may be implemented in connection with any computing environment, such as a network or distributed computing environment. Still further, aspects of the invention may be implemented in or across a plurality of processing chips or devices, and storage may similarly be effected across a plurality of devices. Such devices might include personal computers, network servers, handheld devices, supercomputers, or computers integrated into other systems such as automobiles and airplanes.

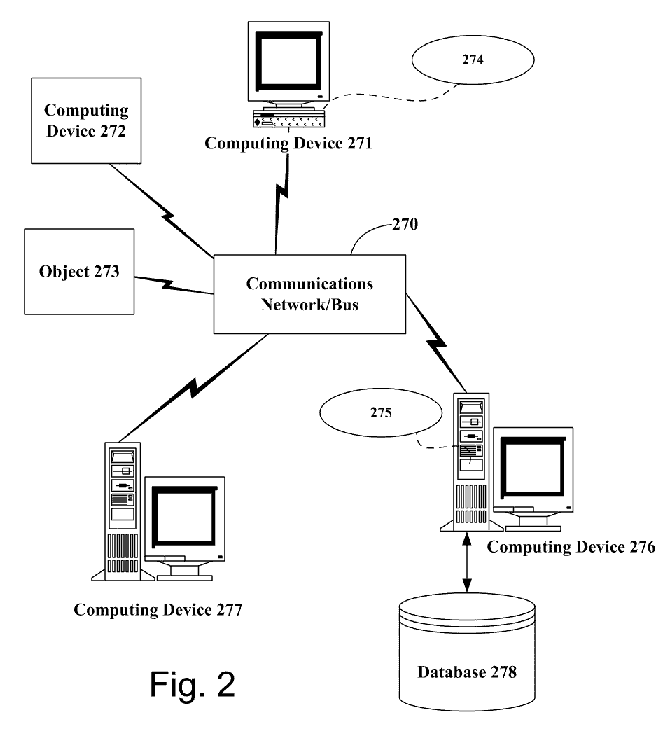

Referring next to FIG. 2, shown is an exemplary networked computing environment in which many computerized processes may be implemented to perform the processes described above. For example, parallel or distributed computing may be part of such a networked environment with various clients on the network of FIG. 2 using and/or implementing systems and methods for displaying context-related social content on web pages. One of ordinary skill in the art can appreciate that networks can connect any computer or other client or server device, or in a distributed computing environment. In this regard, any computer system or environment having any number of processing, memory, or storage units, and any number of applications and processes occurring simultaneously is considered suitable for use in connection with the systems and methods provided.

Distributed computing provides sharing of computer resources and services by exchange between computing devices and systems. These resources and services include the exchange of information, cache storage and disk storage for files. Distributed computing takes advantage of network connectivity, allowing clients to leverage their collective power to benefit the entire enterprise. In this regard, a variety of devices may have applications, objects or resources that may implicate the processes described herein.

FIG. 2 provides a schematic diagram of an exemplary networked or distributed computing environment. The environment comprises computing devices 271, 272, 276, and 277 as well as objects 273, 274, and 275, and database 278. Each of these entities 271, 272, 273, 274, 275, 276, 277 and 278 may comprise or make use of programs, methods, data stores, programmable logic, etc. The entities 271, 272, 273, 274, 275, 276, 277 and 278 may span portions of the same or different devices such as PDAs, audio/video devices, MP3 players, personal computers, etc. Each entity 271, 272, 273, 274, 275, 276, 277 and 278 can communicate with another entity 271, 272, 273, 274, 275, 276, 277 and 278 by way of the communications network 270. In this regard, any entity may be responsible for the maintenance and updating of a database 278 or other storage element.

This network 270 may itself comprise other computing entities that provide services to the system of FIG. 2, and may itself represent multiple interconnected networks. In accordance with an aspect of the invention, each entity 271, 272, 273, 274, 275, 276, 277 and 278 may contain discrete functional program modules that might make use of an API, or other object, software, firmware and/or hardware, to request services of one or more of the other entities 271, 272, 273, 274, 275, 276, 277 and 278.

It can also be appreciated that an object, such as 275, may be hosted on another computing device 276. Thus, although the physical environment depicted may show the connected devices as computers, such illustration is merely exemplary and the physical environment may alternatively be depicted or described comprising various digital devices such as PDAs, televisions, MP3 players, etc., software objects such as interfaces, COM objects and the like.

There are a variety of systems, components, and network configurations that support distributed computing environments. For example, computing systems may be connected together by wired or wireless systems, by local networks or widely distributed networks. Currently, many networks are coupled to the Internet, which provides an infrastructure for widely distributed computing and encompasses many different networks. Any such infrastructures, whether coupled to the Internet or not, may be used in conjunction with the systems and methods provided.

A network infrastructure may enable a host of network topologies such as client/server, peer-to-peer, or hybrid architectures. The “client” is a member of a class or group that uses the services of another class or group to which it is not related. In computing, a client is a process, i.e., roughly a set of instructions or tasks, that requests a service provided by another program. The client process utilizes the requested service without having to “know” any working details about the other program or the service itself. In a client/server architecture, particularly a networked system, a client is usually a computer that accesses shared network resources provided by another computer, e.g., a server. In the example of FIG. 2, any entity 271, 272, 273, 274, 275, 276, 277 and 278 can be considered a client, a server, or both, depending on the circumstances.

A server is typically, though not necessarily, a remote computer system accessible over a remote or local network, such as the Internet. The client process may be active in a first computer system, and the server process may be active in a second computer system, communicating with one another over a communications medium, thus providing distributed functionality and allowing multiple clients to take advantage of the information-gathering capabilities of the server. Any software objects may be distributed across multiple computing devices or objects.

Client(s) and server(s) communicate with one another utilizing the functionality provided by protocol layer(s). For example, HyperText Transfer Protocol (HTTP) is a common protocol that is used in conjunction with the World Wide Web (WWW), or “the Web.” Typically, a computer network address such as an Internet Protocol (IP) address or other reference such as a Universal Resource Locator (URL) can be used to identify the server or client computers to each other. The network address can be referred to as a URL address. Communication can be provided over a communications medium, e.g., client(s) and server(s) may be coupled to one another via TCP/IP connection(s) for high-capacity communication.

In light of the diverse computing environments that may be built according to the general framework provided in FIG. 2 and the further diversification that can occur in computing in a network environment such as that of FIG. 2, the systems and methods provided herein cannot be construed as limited in any way to a particular computing architecture. Instead, the invention should not be limited to any single embodiment, but rather should be construed in breadth and scope in accordance with the appended claims.

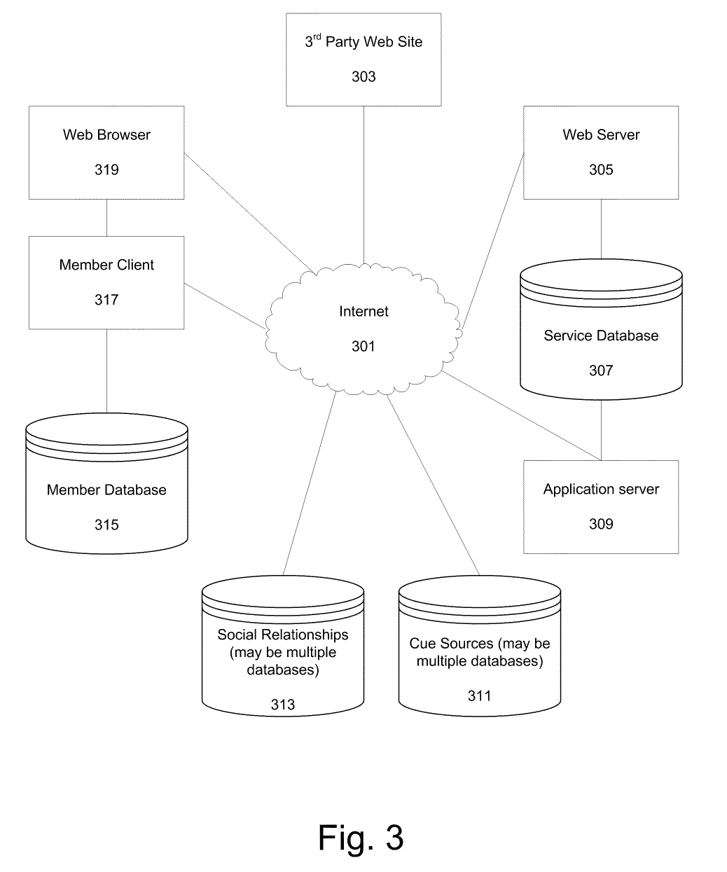

Referring next to FIG. 3, shown is a block diagram illustrating an example architecture of a system for displaying context-related social content on web pages. Shown is a network cloud representing the Internet 301, a 3d party web site 303, a web server 305, a service database 307, an application server 309, multiple databases of cue sources 311, multiple databases of social relationships 313, a member database 315, a member client 317 and a web browser 319. The web server 305, service database 307 and application server 309 comprise a subsystem on which the computer executable instructions reside for providing the service for displaying context-related social content on web pages such as on the example 3^{rd} party web site 303 connected to the Internet 301. The service database stores data needed for providing the service for displaying context-related social content on web pages and is operably linked to the web server 305 and application server 309 such the needed data needed may be accessed by the web server 305 and application server 309. The web server 305 and application server 309 may be located on a single server machine or separate machines, but both are operably linked to and in communication with the service database 307 over a local area network or the like as described above in reference to FIG. 2. The web server 305 and application server 309 are also operably connected to the Internet 301.

Also operably connected to the Internet are the social relationships databases 313 and the cue sources databases, each storing the social relationships and cue sources (described further below) required for displaying context-related social content on web pages. A web browser 319 and member client 317 may be installed on a member's computer, and are in operable communication with each other through an API, for example, as described above in reference to FIG. 1. Both the web browser 319 and member client 317 are operably connected to the Internet in order to access the services provided by the web server 305 and application server 309. Also, the member client 317 is in operable connected to a member database 315 such that information regarding other members may be accessed for displaying context-related social content on web pages regarding the other members. Provided below is a chart of the example components shown in FIG. 3 and associated example functional descriptions. Each component may also have additional and/or different functionality and additional further detailed description and definitions regarding the functionality of the components are provided in the description following the chart below.

Chart of Example Components and their Example Functional Descriptions

| Reference | | | |
|---|---|---|---|
| Number | Component | Description | Functions |
| 303 | 3^{rd}-Party Web | A multitude of web | serves web pages that are rendered |
| | Site 303 | sites accessed by | and presented to the user by the Web |
| | | user via the Web | Browser |
| | | Browser 319 | |
| 319 | Web Browser | An application | renders web pages provided by 3^{rd} |
| | 319 | installed on user's | Party Web Sites and sends user |
| | | computer | commands back to 3^{rd} Party Web |
| | | | Sites |
| 317 | Member Client | An application | integrates with Web Browser via a |
| | 317 | installed on user's | Browser Add-In |
| | | computer | tracks user's browsing activities |
| | | | calculates page theme and requests |
| | | | server for cues |
| | | | displays the “toast” window and |
| | | | shows available cues |
| 315 | Member | Local data storage | contains bookmarks cache |
| | Database 315 | used by Member | contains friends and realms cache |
| | | Client 317 | contains merchants and products |
| | | | identification rules |
| | | | contains user's local settings |
| 301 | Internet 301 | The global | transfers messages and other types of |
| | | communications | data between system's and external |
| | | network | components |
| 305 | Web Server 305 | An application | provides user interface (UI) for |
| | | running in | member account management |
| | | Service's data | (including cues, relationships, |
| | | center | settings) |
| | | | provides UI for system |
| | | | administrators for user and system |
| | | | management |
| 309 | Application | An application | authenticates the Member Client 317 |
| | Server 309 | running in | synchronizes Member Client's local |
| | | Service's data | cache with Service Database 307 |
| | | center | returns relevant cues when Member |
| | | | Client 317 sends a matching request |
| | | | imports cues from Cue Sources into |
| | | | the Service Database 307 |
| 307 | Service | Central data storage | contains social relationships between |
| | Database 307 | | members |
| | | | contains cues from members and |
| | | | from public feeds |
| | | | contains user profile |
| | | | contains user activity tracking and |
| | | | history data |
| 313 | Social | A multitude of | provide social relationships data |
| | Relationship | sources of social | between members |
| | Sources 313 | relationships such | |
| | | as Social | |
| | | Networking sites | |
| | | (e.g. MySpace ® or | |
| | | Facebook ®), email | |
| | | online services (e.g. | |
| | | Hotmail ®, Gmail ®, | |
| | | Yahoo ®), email on- | |
| | | premise | |
| | | applications | |
| | | (Microsoft | |
| | | Outlook ®), etc. | |
| 311 | Cue Sources 311 | A multitude of | provides bookmarks, photos, |
| | | sources of cues | opinions, reviews, articles etc. |
| | | such as Social | includes public cues for which no |
| | | Content Sharing | authentication is required, and |
| | | sites (e.g. | private cues, which are protected by |
| | | Delicious ®, | authentication and authorization |
| | | Flickr ®, | mechanisms |
| | | MySpace ®), | |
| | | Review sites | |
| | | (Yelp ®), | |
| | | Encyclopedia sites | |
| | | (Wikipedia ®) | |

To eliminate the need for a user to visit a dedicated web page with a news feed, cues may be displayed on web sites the user is are already visiting (e.g., 3^{rd} party web site 303 of FIG. 3) as part of the user's daily use of the Internet by accessing the web server 305, application server 309, cue sources database 311, and social relationships 313 database over the Internet 301 via the web browser 319 and member client 317. Note that the term “user” is a general term meaning a user of the Internet. A member is a user who signed up for an account to use a service for displaying context-related social content on web pages. Thus, the term user thus also includes members.

Generally, cues may be summaries of blogs, photos, bookmarks or any other type of social content or objects shared by friends or other entities (individuals or organizations) the user cares about. A cue may have data regarding an object having an indication within an account of another user on another web site that the object is preferred or shared by the other user. Cues typically include but are not limited to such attributes as a Title, Tags that describe their purpose or meaning, a textual description, and a URL pointing to the entire item that is being shared such as a web page stored on a web server or a photograph, or video stored on a web server, for example. In one example embodiment, a cue may be defined below in the section “Definition of Cues” for implementation purposes of one specific example. However, the definition of cues is for purposes of the claimed invention is the more general definition as described above and is not limited to the specific implementation example provided below.

Furthermore, to improve relevance, cues are matched with the content of web pages the user opened in the user's web browser. To accomplish that, the system searches for cues similar to the displayed web page. The concept of similarity between two objects is important to this process.

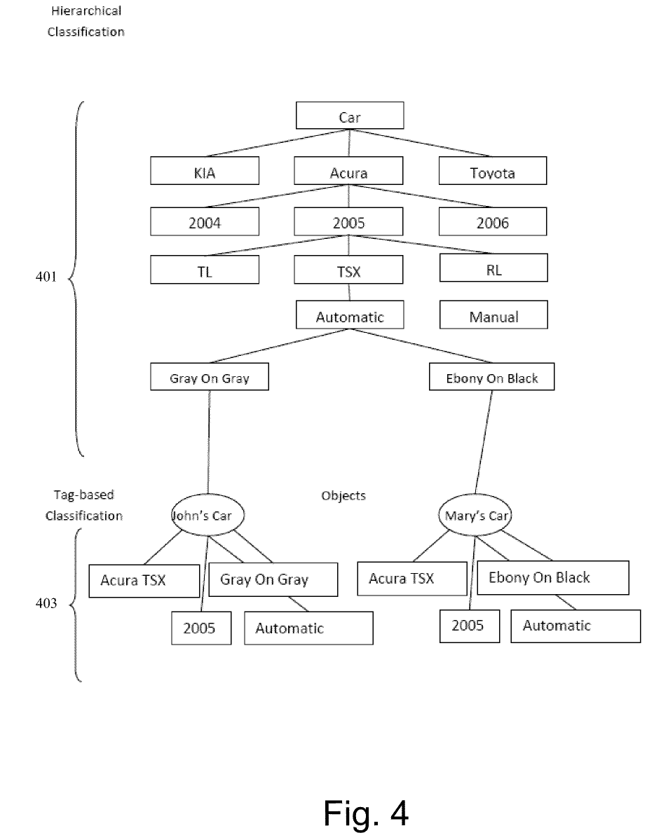

Similarity between objects, denoted Similarity(object1, object2), is based on object classification. Cues, being summaries of objects, inherit the classification from them. Similarity between cues is meant to refer to similarity between their objects. Currently, two approaches are used to classify objects: hierarchical and tag-based classifications. Referring next to FIG. 4, shown is a block diagram illustrating an example of hierarchical 401 and tag-based 403 classification of objects

In hierarchical classification, objects are classified in a hierarchy of classes. An example of such hierarchy is in FIG. 4. Similarity is highest (100%) for objects of exactly the same class. Similarity in a hierarchy 401 is proportional to the depth of the branch that is common to both objects. In tag-based classification 403 objects are classified by tag words. Objects that have one or more matching tags are considered similar. The more tags are matched, the more similar the objects are.

Hierarchical classification is often used on shopping sites such as eBay and Amazon. Tagging is often used in photo-sharing, bookmarking, and other user-driven sites. The major benefit of hierarchical classification 401 is its precision; the main drawback is the effort to enforce the classification among all users. The major benefit of tagging 403 is its low dependency on consensus among users. In turn, tag-based classification tends to be imprecise and sometimes leads to false matches. The processes described herein for displaying context-related social content on web pages may use hierarchical classification, tag-based classifications, or a combination of both.

Example Definition of Cues

The definition of cues is for purposes of the claimed invention is the more general definition as described above and is not limited to the specific implementation example provided below. In one example implementation, a cue entity may comprise of, and is not limited to, the following attributes.

Cue=(Type, Title, ObjectClassifier, Creator, VisibilityRealms, Beneficiary, ActionURL, [other type-specific details])
Type—Type of the cue, including bookmarks, photos, opinions, blogs, purchases etc
Title—Short description of the cue
ObjectClassifier—Set of Tags and/or Position in Hierarchical classification tree which describe the object
Creator—person who created the cue, e.g., wrote a review or bookmarked a web page.
VisibilityRealms—Set of Realms of the Creator, defining who of the user's friends can see this cue.
Beneficiary—A merchant, a not-for-profit organization, or simply a web site, which would benefit from increased sales, membership, or web traffic if the cue were displayed to a friend of the Creator and form his opinion about the object.
Action URL—web link to be clicked by Member to learn more about the cue or the object.

An example of a cue would be a bookmark created by Alex Dillon pointing to the CNN election center page:
Type=“bookmark”
Title=“Election Center”
ObjectClassifier=“US elections”, “news channel”
Creator=“Alex Dillon”
VisibilityRealms=“Friends”, “Colleagues”
Beneficiary=“http://www.cnn.com”
ActionURL=“http://www.cnn.com/ELECTION”

Example Definitions of Other Concepts

Service—the service for displaying context-related social content on web pages

(Service) Member—a user of the Service who signed up for an account

Non-Member—a person who does not have a Service Member account

Realm—a group of friends in which a Member is known under a separate identity (e.g. Work, Friends)

Social Network—A service which offers communication and other features to users and their friends and/or relations

Social Network Interface—an application interface to a social network. Examples include the Yahoo® Messenger as the interface to Yahoo® Social Network, the Microsoft® Outlook email client as an interface to a corporate social network represented by email messages etc.

Social Network Identity—identity of a person in a social network

Friend (of a Member)—A Service Member socially connected to the Member

Non-Member Friend—a Person from the social network of a Service Member who is not a Service Member himself yet.

Cue Source—A web site storing social content such as bookmarks, opinions, photographs, purchases etc. and accessible via the internet.

Merchant—An organization, including for-profit or non-profit entities, that is operating a web site and which would benefit from increased sales, membership, or web traffic.

Sponsored Cue—A Cue, which, if displayed and clicked-on by a Member, will result in a payment to the Service by a Merchant.

Signing Up Users and Setting Up their Computers

When an internet user becomes a member of the service, the following steps, for example, may be performed:
1. User navigates to the sign-up web page of the service.
2. User enters information necessary for establishing a member account, such as his name, email address, and password.
3. User downloads the a Member Client application and installs it on the user's computer
4. User enters other information necessary for providing the service, such as the user's accounts in Cue Sources or Social Networks.

Authorizing Access to Member Cues Via Realms

A member usually has multiple real-life identities (at Work, with Friends) which the member wants to preserve online. The system for displaying context-related social content on web pages (hereafter referred to as the “system”) may employ a grouping concept called Realms which allows one to divide the friends and cues into smaller groups. For example, only friends belonging to realm R1 have access to cues which were assigned to realm R1. Cues and Friends can belong to multiple realms, however.

Importing a User's Cues into the System

Users can share cues created and stored in social content sharing sites with other members of the service for displaying context-related social content on web pages. For example, the process may be performed as follows:
1. User signs in into the account management web site.
2. User enters user names and passwords to all services from which the user wants to import cues.
3. System logs in into these services (i.e, other social content sharing sites) and imports user's cues.
4. User reviews and publishes them to a selection of Realms.

Importing User's Friends into the System

Users can import their contact lists from a variety of Social Relationship Sources. For example, the process may be performed as follows:
1. User signs in into the account management web site.
2. User enters user names and passwords to all services from which the user wants to import the user's friends.
3. System logs into these services and imports user's friends contact information.
4. User reviews and decides which contacts to whom the user wants to send invitations.
5. User chooses the Realm the user wants these contacts to belong to.
6. System sends invitations.
7. Friends accept or reject these invitations.
8. System begins displaying cues from friends who accepted the invite to the user.

Getting Cues from Sources other than Friends

Users can also subscribe to cues by people or organizations other than their friends, for example influential bloggers or professional photographers. These people or organizations usually offer opinions, news, photographs etc to the general public. What is required to obtain access to such public items is the URL or another identifier of the “feed”. For example, the process may be performed as follows:
1. User enters an account management web site of the system.
2. User enters the type of the service, the identifier of the feed, and the realm the user wants this feed to belong.
3. System checks if this identifier already is defined and, if not, creates a record for this feed.
4. System makes the user a Fan of this new feed.
5. System periodically requests from the service the content of this feed and saves it as cues.
6. When displaying cues to the user, the system treats the feed as if it were a friend.

Finding, Displaying and Interacting with Relevant Cues on a Web Page

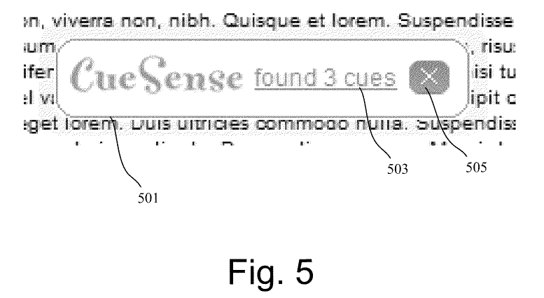

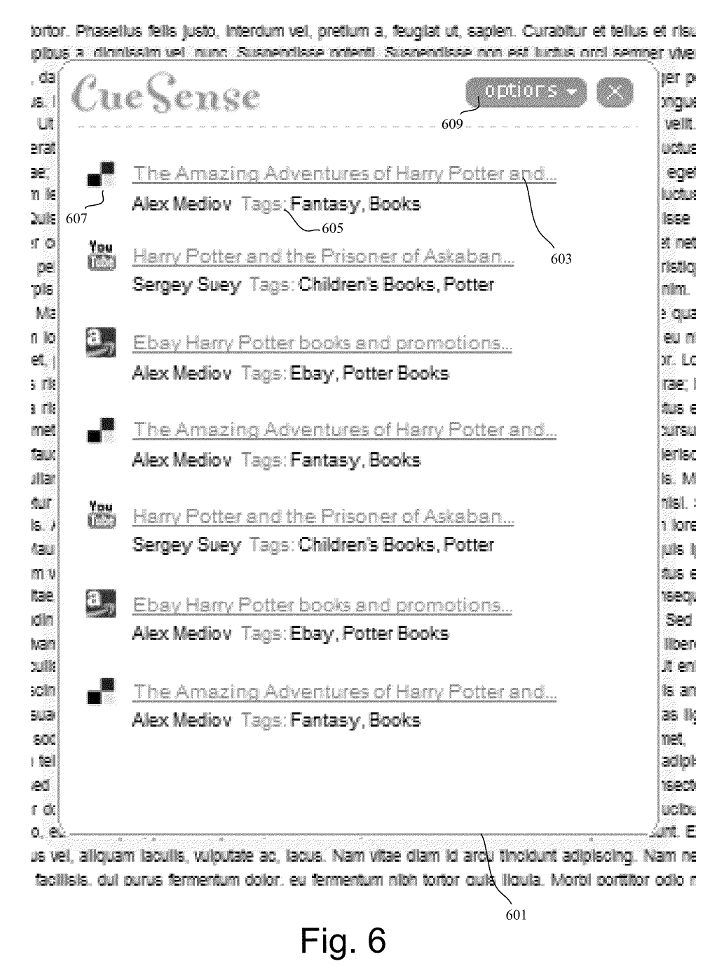

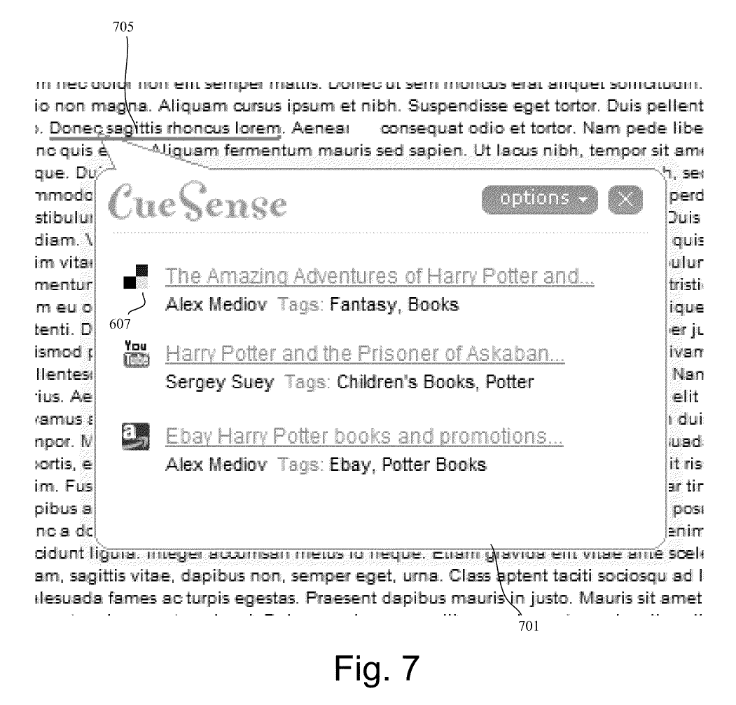

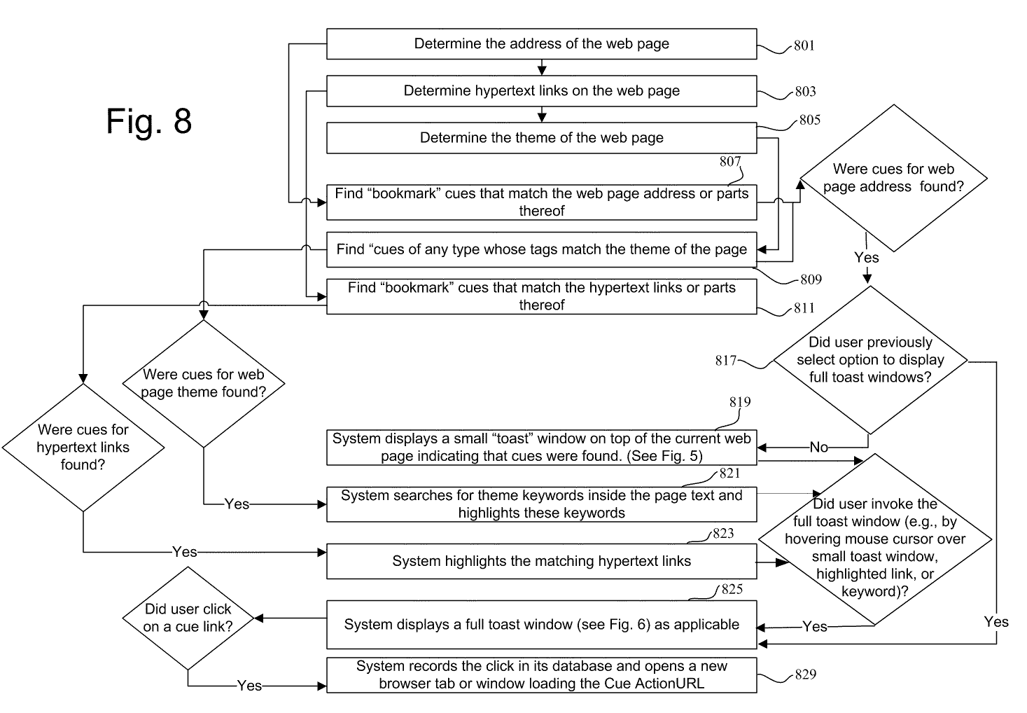

Referring next to FIG. 5 though FIG. 8, shown is a flow chart of an example process for finding and displaying relevant cues on a web page in an example system for displaying context-related social content (FIG. 8), an illustration of an example small “toast” window 501 indicating availability 503 of cues for a web page (FIG. 5), an illustration of an example large “toast” window 601 displaying cues 607 for an entire web page (FIG. 6), and an illustration of an example large “toast” window 701 with cues 607 for keywords or links 705 (FIG. 7).

After a user signs up for the service and downloads the Member Client 317 (shown in FIG. 3), the system may start displaying cues each time the user visits a web page. For example, the system may do the following:
1. Determine 801 the address of the web page.
   a. The web page address is its URL.
2. Determine 803 HyperText Links on the web page.
   a. Links are addresses of other resources on the internet.
3. Determine 805 the theme of the web page.
   a. The theme is a list of keywords most likely to represent the meaning of the content of a web page.
   b. The method for determining the theme is described in Section “Web page summarization.”
4. Find 807 “bookmark” cues that match the web page address or parts thereof, as determined in step 1 above.
   a. Matching is accomplished by comparing the cue Action URL with the web page URL.
5. Find 809 cues of any type whose tags match the theme of the page determined in step 3 above.
   a. Matching may be performed by a ranking algorithm described in Section “Finding similar cues in tag-based classification.”
6. Find 811 “bookmark” cues that match the Hypertext Links or parts thereof, as determined in step 2 above.
   a. Matching is accomplished by comparing the cue Action URL with the Link URL.
7. If cues for the web page address (step 4 above) or web page theme (step 5 above) were found, the system will determine 817 whether the user previously selected an option to display full toast windows. If the user previously selected an option to display full “toast” windows, then the system will display 825 a full “toast” window 601 such as that shown in FIG. 6, for example, indicating that cues were found. If the user did not previously select an option to display full toast windows, then the system will display will display 819 a small “toast” window 501 on top of the current web page with an indication 503 that cues were found. See FIG. 5 for an illustration of an example small “toast” window 501. The small “toast” window 501 and full “toast” window 601 may also have a means for closing the window, such as a button 505 as shown on the “small “toast” window 501 of FIG. 5.
   a. If the user hovers the mouse cursor over the small “toast” popup window 501, then the full “toast” window 601 will be displayed 825. The full “toast” window 601 may also have an “options” menu 609 (e.g., a drop-down menu) for the user to choose further options and view further information regarding the cues, cue attributes, and display of “toast” windows.
8. If cues for the web page theme (step 5 above) were found, the system will search 821 for the theme keywords inside the page text and highlight these keywords (e.g., underline, change the background color or font, or by using other means of visually highlighting a web page element). Shown in FIG. 7 is an example a keyword 705 highlighted in such a manner.
   a. If the user hovers the mouse cursor over that keyword 705, the full “toast” window 701 will be displayed 825, pointing to the keyword 705 as shown in FIG. 7.
9. If cues for Hypertext Links (step 6 above) were found, the system will highlight 823 the link (underline, change the background color or font, or by using other means of visually highlighting a web page element).
   a. If the user hovers the mouse cursor over that link, the full “toast” window 701 will be displayed 825, pointing to the link as shown in FIG. 7.
10. If the user invoked the full “toast” window as the result of steps 7, 8, or 9 above (or the full “toast” window 601 was displayed 825 automatically as a result of user previously selecting an option to display full “toast” windows), the system may, for example, display the found cues in the full “toast” window as follows:
   a. For each displayed cue 607, the system shows a hypertext link 603 that is titled using the Cue Title and links to the Cue ActionURL in the full “toast” window.
   b. The system can also display other cue attributes (e.g. Tags 605) in the full “toast” window to allow the user to better decide on its relevance.
11. If the user clicks on any of the cue links in the toast window, the system will record 829 the click in its database and open a new browser tab or window loading the Cue ActionURL.

Web Page Summarization

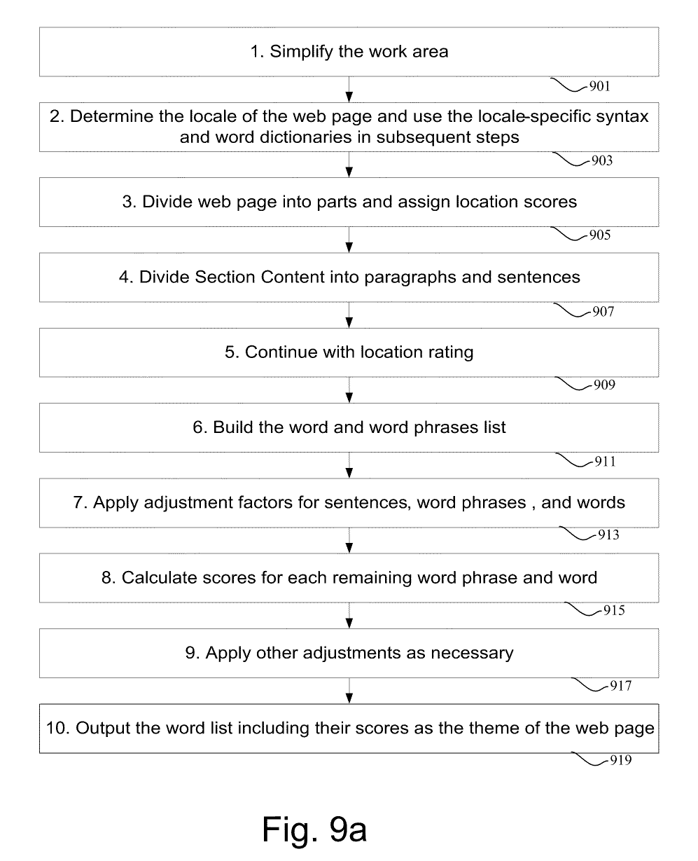

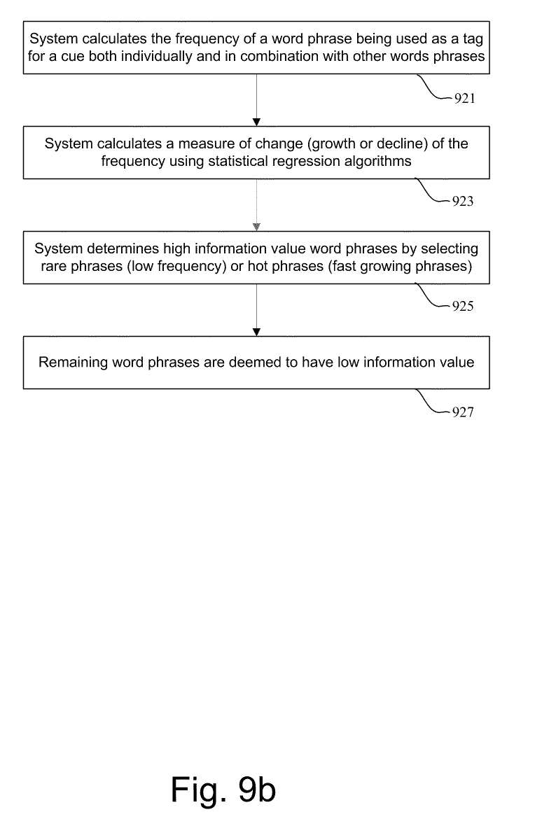

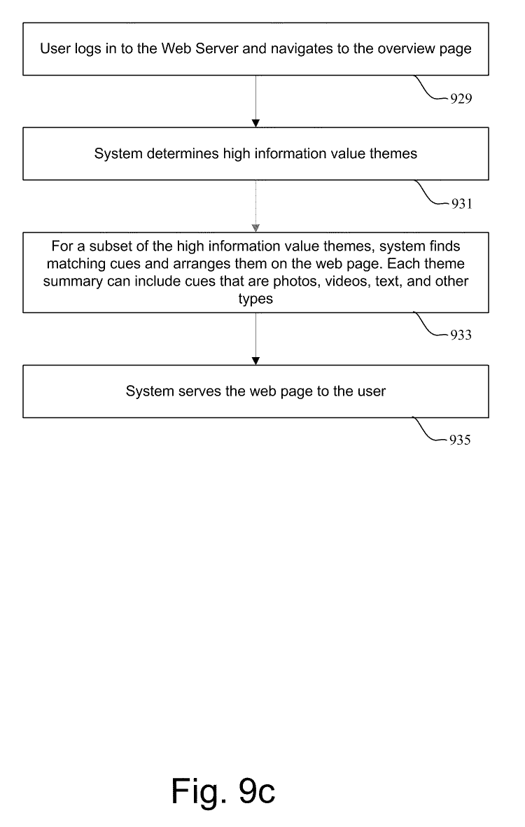

Referring next to FIG. 9a, shown is a flow chart of an example process for web page summarization in an example system for displaying context-related social content. In one example embodiment, the system may employ the following process to determine the “theme” of a web page. The theme is a set of textual tags with scores. The scores provided below are provided as an example, and different and/or additional scores, scoring models and mechanisms are contemplated and may also be employed. For example, the process may be performed as follows:
1. Simplify 901 the work area.
   a. Ignore Advertising Frames.
   b. Ignore Navigational Frames.
2. Determine 903 the locale of the web page and use the locale-specific syntax and word dictionaries in subsequent steps.
3. Divide 905 the web page into parts and assign location scores.
   a. Divide web page into Page Title, Meta tag Section, Section Titles, and Section Content.
   b. Score Page Title as “High”.
   c. Score meta tag sections “keywords” and “description” for selected sites that are known to truthfully populate these tags (e.g. eBay®, Amazon®, etc.) as “High”
   d. Score Section Title as “High”.
   e. Score Sections Content as “Medium”.
4. Divide 907 Section Content into paragraphs and sentences.
   a. Determine paragraphs by using the syntax dictionary looking for delimiters (e.g. Enter etc.).
   b. Determine sentences in paragraphs by using the syntax dictionary looking for delimiters (e.g. .‘,’ ‘?’, ‘!’, ‘;’ etc.)
5. Continue 909 with location rating.
   a. Score first paragraph as “Medium”.
      i. First paragraphs usually establish the premise in an English text.
   b. Score last paragraph as “Medium”.
      i. Last paragraphs usually summarize the whole page in English text.
   c. Score first sentence of paragraph as “Medium”.
      i. It usually summarizes the meaning of the paragraph.
   d. Score all other paragraphs and sentences as “Below Medium”.
6. Build 911 the word and word phrases list.
   a. Divide sentences into single words using the syntax dictionary looking for delimiters (e.g. ‘,’, ‘:’, ‘(‘,’)’, ‘[’, ‘]’, ‘{’, ‘}’, “ ”, space, tab, etc.).
   b. Handle exceptions like Dr., Mr., month names, weekday names, a.m., p.m., while using the dictionary.
   c. Find words which start with a capital letter and bundle subsequent capitalized words in one tag.
7. Apply 913 adjustment factors for sentences, word phrases, and words. Applying adjustment factors is optional. In particular, the example adjustment factors below may be performed optionally.
   a. Decrease scores for sentences with examples (start with “For example”, “such as”).
   b. Increase scores for phrases of two or more capitalized words.
   c. Increase scores for Person Names.
   d. Decrease score of low information value words such as pronouns, verbs, articles by using the dictionary.
      i. Examples of low value words: a, about, do, did, enough, etc, even, it, there, where, than, that, etc.
   e. Decrease scores for low information value words such as commonly used words like “man”, “people”, etc.
   f. Remove numbers.
8. Calculate 915 scores for each remaining word phrase and word
   a. Calculate number of appearances of each word (phrase) in its exact form.
   b. Calculate number of appearances of stem versions of each word (stemming or reduction of words to their roots).
   c. Increase score for each word considering the figures computed in a) and b)
9. Apply 917 other adjustments as necessary.
10. Output 919 the word list including their scores as the theme of the web page.

Determining the Information Value of Word Phrases

Referring next to FIG. 9b, shown is a flow chart of an example process for determining the information value of word phrases in an example system for displaying context-related social content. To determine the information value of a word phrase (consisting of one or more words), the system can keep frequency and other derived statistics of their use as cue tags. For example, the process may be performed as follows:
1. The system calculates 921 the frequency of a word phrase being used as a tag for a cue both individually and in combination with other words phrases.
2. The system calculates 923 a measure of change (growth or decline) of the frequency using statistical regression algorithms.
3. The system determines 925 high information value word phrases by selecting rare phrases (low frequency) or hot phrases (fast growing phrases).
4. Remaining word phrases are deemed 927 to have low information value by the system.

Automatically Creating Tags for Cues

Often cues are imported into the System without having any tags. To allow such cues to be used in matching, information value calculations etc., the System can create cue tags automatically using methods that are specific to the type of the cue. For bookmarks, blogs, and web pages in general, the System can employ the method described in section “Web page summarization” above. For images, including photos and videos, the system can use commercially available methods of image annotation and object recognition. For audio, the system can use commercially available methods of speech recognition.

Displaying Cues Relevant to High Information Value Word Phrases on an Overview Page

Referring next to FIG. 9c, shown is a flow chart of an example process for displaying cues relevant to high information value word phrases on an overview page in an example system for displaying context-related social content. To give users an overview of what is being shared by the user's friends and feeds, the system can select a set of themes with high information value and display matching cues on a web page served by the web server 305 (shown in FIG. 3). For example, the process may be performed as follows:
1. A user logs in 929 to the Web Server 305 and navigates to the overview page.
2. The system determines 931 high information value themes.
3. For a subset of the high information value themes, the system finds 933 matching cues and arranges them on the web page. Each theme summary can include cues that are photos, videos, text, and other types.
4. The system serves 935 this web page to the user.

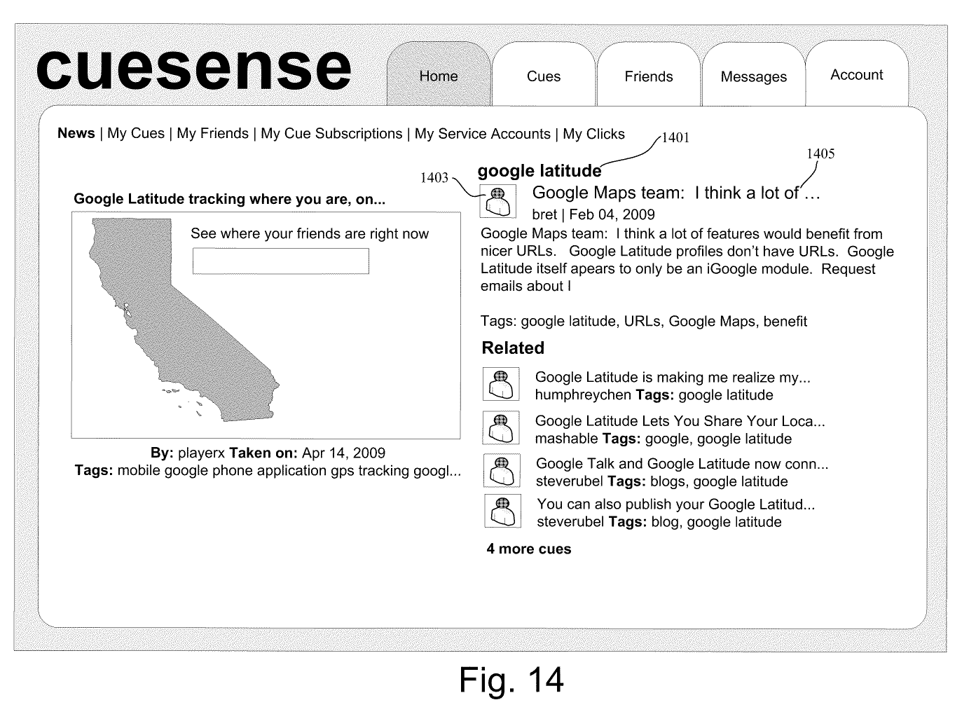

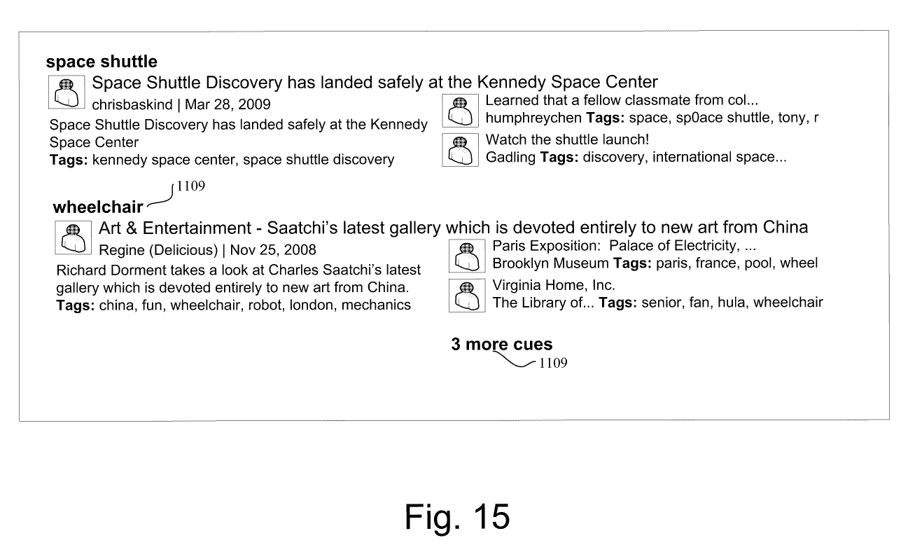

Referring next to FIGS. 14 and 15, shown are illustrations of a top portion and bottom portion, respectively, of an example overview page in an example system for displaying context-related social content. Shown in the top portion in FIG. 14 are cues matching a high information value theme. When a member clicks on a cue icon 1403, it opens the Member/Feed profile associated with that cue. Above the cues is a link 1401 to the topic profile page regarding a topic to which the cues are related. Next to the cue icon 1403 is a link 1405 which may be an ActionURL associated with the cue (a web link to be clicked by the member to learn more about the cue or the object). There are also additional links 1109 as shown on the bottom section of the example overview page which open the topic public profile associated with a topic of one or more cues.

Finding Similar Cues in Hierarchy-Based Classification

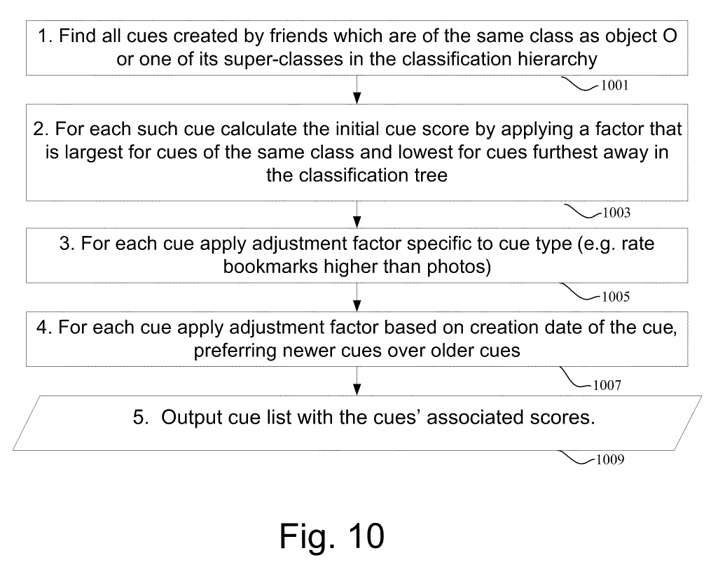

Referring next to FIG. 10, shown is a flow chart of an example process for finding similar cues in hierarchy-based classification in an example system for displaying context-related social content. For example, given is an object O with its class (location in the hierarchical classification tree). In the process described below, the system will build a list of cues which are sorted by their similarity to the object. This cue list can be then used for displaying cues in the “toast” window, on the overview page or on any 3^{rd} party web page. For example, the process may be performed as follows:
1. Find 1001 all cues created by friends which are of the same class as object O or one of its super-classes in the classification hierarchy.
2. For each such cue calculate 1003 the initial cue score by applying a factor that is largest for cues of the same class and lowest for cues furthest away in the classification tree.
3. For each cue apply 1005 a score adjustment factor specific to cue type (e.g., rate bookmarks higher than photos).
4. For each cue apply 1007 a score adjustment factor based on creation date of the cue, preferring newer cues over older cues.
5. Output 1009 the cue list with the cues' associated scores.

Finding Similar Cues in Tag-Based Classification

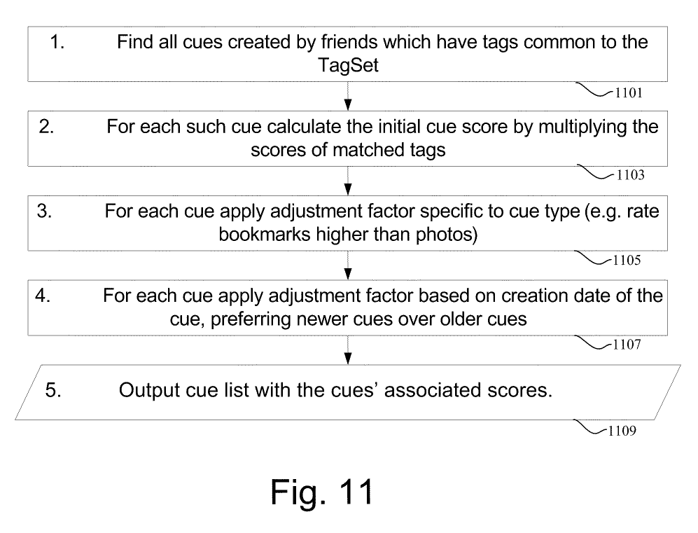

Referring next to FIG. 11, shown is a flow chart of an example process for finding similar cues in tag-based classification in an example system for displaying context-related social content. For example, given is a set of tags TagSet {(tag,score)} with associated scores (e.g. the result of a web page theme computation). In this process the system builds a list of cues which are sorted by their similarity to the TagSet. This cue list can be then used for displaying cues in the “toast” window, on the overview page or on any 3 party web page. For example, the process may be performed as follows:
1. Find 1101 all cues created by friends which have tags common to the TagSet.
2. For each such cue, calculate 1103 the initial cue score by multiplying the scores of matched tags.
3. For each cue apply 1107 a score adjustment factor specific to cue type (e.g., rate bookmarks higher than photos).
4. For each cue, apply 1107 a score adjustment factor based on creation date of the cue, preferring newer cues over older cues.
5. Output 1109 the cue list with the cues' associated scores.

Allowing Merchants to Specify Sponsored Cues

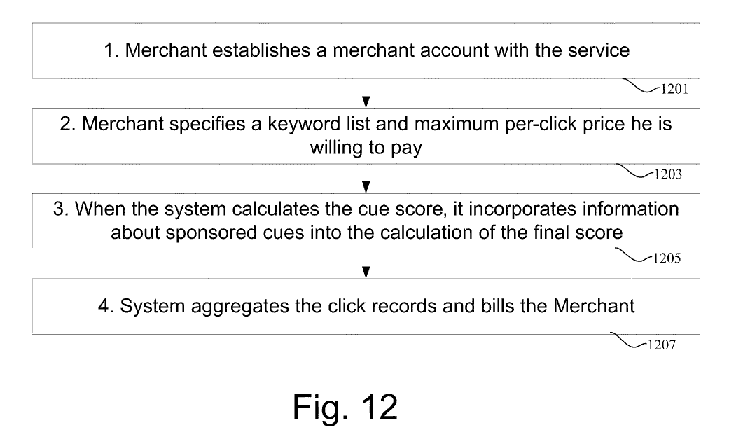

Referring next to FIG. 12, shown is a flow chart of an example process for allowing merchants to specify sponsored cues in an example system for displaying context-related social content. While providing a valuable service to end-users, the system may incorporate several methods for sponsorship-based monetization. It allows merchants or web site owners to specify their maximum per-click price they are willing to pay if the user clicks on a cue link pointing to their site. For example, the process may be performed as follows:
1. Merchant establishes 1201 a merchant account with the service.
2. Merchant specifies 1203 a keyword list and maximum per-click price the merchant is willing to pay.
   a. If a cue matches the specified keywords by its tags, the cue is subsequently displayed to the user in the “toast” window, and the user clicks on the cue link, the merchant will pay up-to the bidden price.
3. When the system calculates the cue score, it incorporates 1205 information about sponsored cues into the calculation of the final score.
   a. See the “Re-scoring the ranked cue list according to Merchant Sponsorship status” section below.
4. The system aggregates 1207 the click records and bills the Merchant.

Re-Scoring the Ranked Cue List according to Cue Sponsorship Status

To ensure the display of sponsored cues in the “toast” window, the system can apply re-scoring methods that improve the probability of sponsored cue display. In some instances, the system may specify a target for the percentage of sponsored cues to be included in the ranked cue list, and a quality cut-off bar for the sponsored sue similarity score. For example, the process may be performed as follows:
1. Find cues using the non-sponsored similarity calculation methods as described above.
2. For each cue, apply a score adjustment factor based on cue sponsorship status.
   a. The system chooses a factor which ensures the attainment of the sponsored cue percentage target.
   b. The system will further choose factors to maximize the expected return from displaying the sponsored link, taking into account such information as the bidden click price, previous history of clicks on the sponsored cue, and other information.
3. The system uses the quality cut-off bar for similarity scores to prevent poorly matching cues to be promoted to a higher rank based solely on their financial return.
4. The re-scored cue list is subsequently used for display in the “toast window”, as described in “Finding, displaying, and interacting with relevant cues on a web page” section above.

Distributing Cues to Member Database

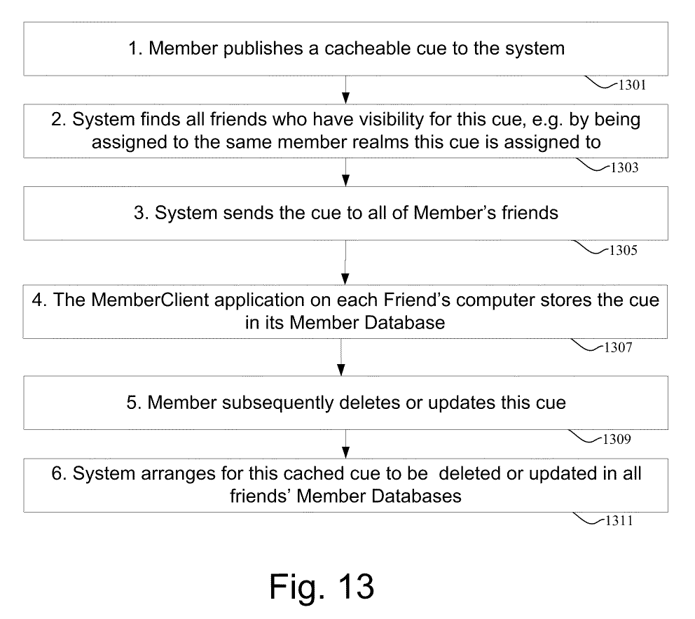

Referring next to FIG. 13, shown is a flow chart of an example process for distributing cues to member databases in an example system for displaying context-related social content. For performance reasons and to avoid sending the browsing history of the user to the server, the system employs the Member Database 315 (shown in FIG. 3) containing a local cache of cues shared by friends. The Application Server 309 is responsible for keeping this database up-to-date with the Service Database 307. Only certain types of cues are cached. For example, bookmarks are cached because without them, being stored locally, the system would have to send the URL of the opened web page to the server to determine cues as described in “Finding, displaying, and interacting with relevant cues on a web page” section above. For example, the process may be performed as follows:
1. A member publishes 1301 a cacheable cue to the system.
2. The system 1303 finds all friends who have visibility for the cue, e.g., by being assigned to the same member realms the to which the cue is assigned.
3. The system sends 1305 the cue to all of the member's friends.
4. A Member Client application 317 on each friend's computer stores 1307 the cue in its Member Database 315.
5. The member subsequently deletes or updates 1309 the cue.
6. The system arranges for this cached cue to be deleted or updated 1311 in all the member's friends' Member Databases 315.

It is noted that the foregoing examples have been provided merely for the purpose of explanation and are in no way to be construed as limiting of the present invention. While the invention has been described with reference to various embodiments, it is understood that the words which have been used herein are words of description and illustration, rather than words of limitations. Further, although the invention has been described herein with reference to particular means, materials and embodiments, the invention is not intended to be limited to the particulars disclosed herein; rather, the invention extends to all functionally equivalent structures, methods and uses, such as are within the scope of the appended claims. Those skilled in the art, having the benefit of the teachings of this specification, may effect numerous modifications thereto and changes may be made without departing from the scope and spirit of the invention in its aspects.

What is claimed is:

1. A method for displaying context-related social content on web pages wherein one or more computer processors cause performance of steps comprising:
matching at least one cue with content of at least one web page served by a web site a user has currently open in a web browser of the user, said cue containing social content or objects from other web sites than the web site serving the web page the user currently has open in the web browser; and
automatically displaying the at least one cue on the web page currently open in the web browser of the user.

2. The method of claim 1, further comprising first obtaining cues to be matched that are shared by other users associated with the user, said cues automatically obtained from one or more of the other web sites.

3. The method of claim 2 wherein the obtaining cues to be matched comprises:
using account credentials provided by the other users associated with the user to automatically obtain access to data within at least one account of the other users on one or more of the other web sites; and
saving at least part of the obtained data as part of a cue to that is available to the user to be matched.

4. The method of claim 3 wherein the at least part of the obtained data to be saved as part of the cue available to the user is data regarding an object having an indication within the at least one account of the other users on the one or more of the other web sites that the object is preferred by one of the other users associated with the at least one account.

5. The method of claim 4 wherein the object is one of: a bookmark of a web site of one of the other users, a web site saved as a favorite web site of one of the other users, a photo, an opinion, a blog, a purchase of one of the other users, a product of one of the other users.

6. The method of claim 1, further comprising first obtaining cues to be matched by:
receiving an identifier of a data feed from the user;
automatically providing an identifier of the data feed to a service of the data feed;
automatically requesting content of the feed; and
saving at least a portion of the content of the data feed as a cue.

7. The method of claim 1 wherein the matching at least one cue with content of the at least one web page comprises:
generating a list of keywords representing a theme of the content of at least one web page served by a web site a user has currently open in a web browser of the user; and
finding cues having tags that match the keywords.

8. The method of claim 7 wherein the automatically displaying the at least one cue comprises:
determining whether cues having tags that match the keywords were found; and
automatically displaying a popup window on the at least one web page indicating that cues were found having a full list of all cues found if the user previously selected to display such a popup window;
automatically displaying a popup window on the at least one web page instead of and larger than the popup window indicating cues were found, said larger popup window having a full list of all cues found and displayed if the user previously selected a setting to display the larger popup window instead.

9. The method of claim 7 wherein the generating a list of keywords representing a theme of the content of at least one web page comprises:
dividing the at least one web page into parts and assign location scores of content associated with each part;
calculating a number of appearances of selected words from the content;
calculating a number of appearances of stem versions of each selected word in the content;
generating a keyword list based on the selected words; and
assigning scores to each keyword in the keyword list according to the location scores, calculation of number of appearances of selected words and stem versions of each selected word.

10. The method of claim 9 further comprising:
adjusting scores of one or more of the keywords in the keyword list according to an information value of the word determined by:
calculating a frequency of a word or phrase being used as a tag for a cue both individually and in combination with other words or phrases;
calculating a measure of change of the frequency; and
determining a high information value word or phrase as those words or phrases having a low frequency or those words or phrases increasing in frequency over a determined amount of increase in frequency and determining low information value words or phrases as those not determined as high information value words or phrases.

11. The method of claim 10 further comprising displaying cues relevant to one or more of the high information value word phrases on an overview page.

12. A system for displaying context-related social content on web pages comprising:
means for matching at least one cue with content of at least one web page served by a web site a user has currently open in a web browser of the user, said cue containing social content or objects from other web sites than the web site serving the web page the user currently has open in the web browser; and
means for automatically displaying the at least one cue on the web page currently open in the web browser of the user.

13. The system of claim 12, further comprising means for first obtaining cues to be matched that are shared by other users associated with the user, said cues automatically obtained from one or more of the other web sites.

14. The system of claim 13 wherein the means for obtaining cues to be matched comprises:
means for using account credentials provided by the other users associated with the user to automatically obtain access to data within at least one account of the other users on one or more of the other web sites; and
means for saving at least part of the obtained data as part of a cue to that is available to the user to be matched.

15. The system of claim 14 wherein the at least part of the obtained data to be saved as part of the cue available to the user is data regarding an object having an indication within the at least one account of the other users on the one or more of the other web sites that the object is preferred by one of the other users associated with the at least one account.

16. The system of claim 15 wherein the object is one of: a bookmark of a web site of one of the other users, a web site saved as a favorite web site of one of the other users, a photo, an opinion, a blog, a purchase of one of the other users, a product of one of the other users.

17. The system of claim 12, further comprising means for first obtaining cues to be matched comprising:
means for receiving an identifier of a data feed from the user;
means for automatically providing an identifier of the data feed to a service of the data feed;
means for automatically requesting content of the feed; and
means for saving at least a portion of the content of the data feed as a cue.

18. The system of claim 12 wherein the means for matching at least one cue with content of the at least one web page comprises:
means for generating a list of keywords representing a theme of the content of at least one web page served by a web site a user has currently open in a web browser of the user; and
means for finding cues having tags that match the keywords.

19. The system of claim 18 wherein the means for automatically displaying the at least one cue comprises:
means for determining whether cues having tags that match the keywords were found; and
means for automatically displaying a popup window on the at least one web page indicating that cues were found having a full list of all cues found if the user previously selected to display such a popup window;
means for automatically displaying a popup window on the at least one web page instead of and larger than the popup window indicating cues were found, said larger popup window having a full list of all cues found and displayed if the user previously selected a setting to display the larger popup window instead.

20. The system of claim 18 wherein the means for generating a list of keywords representing a theme of the content of at least one web page comprises:
means for dividing the at least one web page into parts and assign location scores of content associated with each part;
means for calculating a number of appearances of selected words from the content;
means for calculating a number of appearances of stem versions of each selected word in the content;
means for generating a keyword list based on the selected words; and
means for assigning scores to each keyword in the keyword list according to the location scores, calculation of number of appearances of selected words and stem versions of each selected word.

21. The system of claim 20 further comprising:
means for adjusting scores of one or more of the keywords in the keyword list according to an information value of the word comprising:
means for calculating a frequency of a word or phrase being used as a tag for a cue both individually and in combination with other words or phrases;
means for calculating a measure of change of the frequency; and
means for determining a high information value word or phrase as those words or phrases having a low frequency or those words or phrases increasing in frequency over a determined amount of increase in frequency and determining low information value words or phrases as those not determined as high information value words or phrases.

22. The system of claim 21 further comprising means for displaying cues relevant to one or more of the high information value word phrases on an overview page.

23. A computer readable medium having computer executable instructions thereon for displaying context-related social content on web pages, said computer executable instructions comprising instructions for:
matching at least one cue with content of at least one web page served by a web site a user has currently open in a web browser of the user, said cue containing social content or objects from other web sites than the web site serving the web page the user currently has open in the web browser; and
automatically displaying the at least one cue on the web page currently open in the web browser of the user.

24. The computer readable medium of claim 23, further comprising first obtaining cues to be matched that are shared by other users associated with the user, said cues automatically obtained from one or more of the other web sites.

25. The computer readable medium of claim 24 wherein the instructions for obtaining cues to be matched comprise instructions for:
using account credentials provided by the other users associated with the user to automatically obtain access to data within at least one account of the other users on one or more of the other web sites; and
saving at least part of the obtained data as part of a cue to that is available to the user to be matched.

26. The computer readable medium of claim 25 wherein the at least part of the obtained data to be saved as part of the cue available to the user is data regarding an object having an indication within the at least one account of the other users on the one or more of the other web sites that the object is preferred by one of the other users associated with the at least one account.

27. The computer readable medium of claim 26 wherein the object is one of: a bookmark of a web site of one of the other users, a web site saved as a favorite web site of one of the other users, a photo, an opinion, a blog, a purchase of one of the other users, a product of one of the other users.

28. The computer readable medium of claim 23, further comprising instructions for first obtaining cues to be matched comprising instructions for:
receiving an identifier of a data feed from the user;
automatically providing an identifier of the data feed to a service of the data feed;
automatically requesting content of the feed; and
saving at least a portion of the content of the data feed as a cue.

29. The computer readable medium of claim 23 wherein the instructions for matching at least one cue with content of the at least one web page comprise instructions for:
generating a list of keywords representing a theme of the content of at least one web page served by a web site a user has currently open in a web browser of the user; and
finding cues having tags that match the keywords.

30. The computer readable medium of claim 29 wherein the instructions for automatically displaying the at least one cue comprise instructions for:
determining whether cues having tags that match the keywords were found; and
automatically displaying a popup window on the at least one web page indicating that cues were found having a full list of all cues found if the user previously selected to display such a popup window;
automatically displaying a popup window on the at least one web page instead of and larger than the popup window indicating cues were found, said larger popup window having a full list of all cues found and displayed if the user previously selected a setting to display the larger popup window instead.

31. The computer readable medium of claim 29 wherein the instructions for generating a list of keywords representing a theme of the content of at least one web page comprise instructions for:
dividing the at least one web page into parts and assign location scores of content associated with each part;
calculating a number of appearances of selected words from the content;
calculating a number of appearances of stem versions of each selected word in the content;
generating a keyword list based on the selected words; and
assigning scores to each keyword in the keyword list according to the location scores, calculation of number of appearances of selected words and stem versions of each selected word.

32. The computer readable medium of claim 31 further comprising instructions for:
adjusting scores of one or more of the keywords in the keyword list according to an information value of the word, said instructions for adjusting scores comprising:
calculating a frequency of a word or phrase being used as a tag for a cue both individually and in combination with other words or phrases;
calculating a measure of change of the frequency; and
determining a high information value word or phrase as those words or phrases having a low frequency or those words or phrases increasing in frequency over a determined amount of increase in frequency and determining low information value words or phrases as those not determined as high information value words or phrases.

33. The computer readable medium of claim 32 further comprising instructions for displaying cues relevant to one or more of the high information value word phrases on an overview page.
